(19) United States
(12) Patent Application Publication
(10) Pub. No.: US 2020/0065952 A1
(43) Pub. Date: Feb. 27, 2020

(54) ROBOTIC MAPPING FOR TAPE LIBRARIES

(71) Applicant: International Business Machines Corporation, Armonk, NY (US)

(72) Inventors: Ben Rawlins, Tucson, AZ (US); Larry Hogan, Tucson, AZ (US); Shaun Harrington, Sahuarita, AZ (US); Emmanuel Barajas Gonzalez, Guadalajara (MX)

(73) Assignee: International Business Machines Corporation, Armonk, NY (US)

(21) Appl. No.: 16/112,670

(22) Filed: Aug. 25, 2018

(51) Int. Cl. G06T 7/00; G11B 5/008

(52) U.S. Cl. CPC G06T 7/001; G11B 5/00813; G06T 2200/08; H04N 13/221; G06T 2207/30108; G06T 2207/10012; G06T 2207/10048; G06T 2200/04

(57) ABSTRACT

A method for diagnosing problems in tape libraries is disclosed. In one embodiment, such a method includes attaching, to a robot of a tape library, one or more scanning devices to scan internal components and features of the tape library. As the robot moves within the tape library, the method captures, using the one or more scanning devices, three-dimensional (3D) data describing physical locations of the internal features and components. This 3D data is compiled to generate a map of the internal components and features. The method compares the map to a 3D model of the tape library to identify differences between the map and the 3D model. Problems within the tape library may be identified from these differences. A corresponding system and computer program product are also disclosed.

### BACKGROUND

### Field of the Invention

This invention relates to systems and methods for robotically mapping features of data storage systems such as tape libraries.

### Background of the Invention

A tape library is an automated data storage system used to store data on magnetic tape cartridges. A tape library typically includes tape drives for reading and writing information to magnetic tape cartridges, access ports for entering and removing cartridges from the tape library, and a moving robot (e.g., a cartridge accessor) to physically transport tape cartridges between storage cells, drives, and access ports. The robotics associated with the cartridge accessor enable the cartridge accessor to move in left and right directions (X-motion) and up and down directions (Y-motion). The cartridge accessor typically includes motors and controller cards that require power and the ability to communicate with a stationary library controller.

Currently, machine downtime is one of the largest problems in data and IT centers. The primary cause of downtime for tape libraries is the need for physical intervention. Physical intervention may be required for problems such as stuck grippers, misaligned tapes, misplaced magazines, or physical objects inside the tape library. Such physical intervention is costly in terms of time and money because it requires on site personnel. For example, it is impossible to remotely dial into a tape library and discover that a screw was inadvertently left in a cell during installation. Logs often do not indicate what caused the problem, but rather simply identify the symptoms of a problem such as a gripper experiencing unexpected hard stops. Furthermore, after a physical problem in a tape library is fixed, the robotics of the tape library may need to recalibrate. This is often an extremely slow and inefficient process that may further extend an outage. For example, a full-size TS3500 tape library may take four hours to recalibrate.

In view of the foregoing, what are needed are systems and methods to reduce downtime in data and IT centers. Ideally, such systems and methods will enable remote diagnosis of problems in machines such as tape libraries.

### SUMMARY

The invention has been developed in response to the present state of the art and, in particular, in response to the problems and needs in the art that have not yet been fully solved by currently available systems and methods. Accordingly, systems and methods have been developed to more effectively and efficiently diagnose problems in tape libraries. The features and advantages of the invention will become more fully apparent from the following description and appended claims, or may be learned by practice of the invention as set forth hereinafter.

Consistent with the foregoing, a method for diagnosing problems in tape libraries is disclosed. In one embodiment, such a method includes attaching, to a robot of a tape library, one or more scanning devices to scan internal components and features of the tape library. As the robot moves within the tape library, the method captures, using the one or more scanning devices, three-dimensional (3D) data describing physical locations of the internal features and components. This 3D data is compiled to generate a map of the internal components and features. The method compares the map to a 3D model of the tape library to identify differences between the map and the 3D model. Problems within the tape library may be identified from these differences.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one embodiment of network environment in which systems and methods in accordance with the invention may be implemented;

FIG. 2 is a perspective view of one embodiment of tape library for use in the network environment of FIG. 1;

FIG. 3 is a perspective view of one embodiment of a base frame for use with the tape library of FIG. 2;

FIG. 4 is a high-level block diagram providing an overview of systems and methods in accordance with the invention;

FIG. 5 is a high-level block diagram showing a problem diagnosis module and associated sub-modules in accordance with the invention;

FIG. 6 is a process flow diagram showing one embodiment of a method for diagnosing problems in a tape library by acquiring and analyzing physical location data within the tape library; and

FIG. 7 is a process flow diagram showing one embodiment of a method for diagnosing problems in a tape library by acquiring and analyzing temperature data within the tape library.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

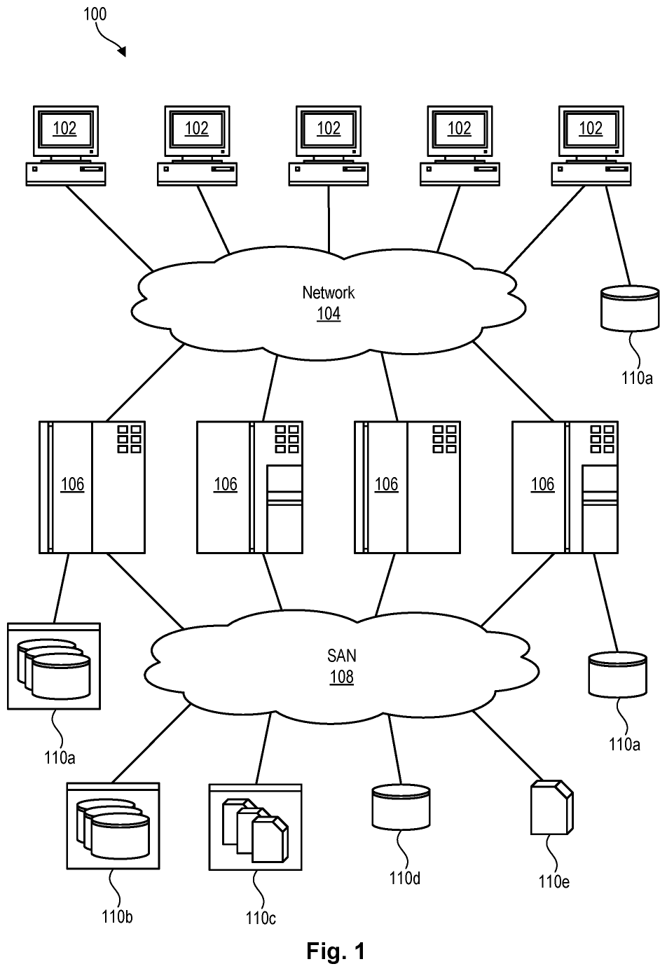

Referring to FIG. 1, one example of a network environment 100 is illustrated. The network environment 100 is presented to show one example of an environment where systems and methods in accordance with the invention may be implemented. The network environment 100 is presented by way of example and not limitation. Indeed, the systems and methods disclosed herein may be applicable to a wide variety of different network environments, in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for and respond to requests from the client computers 102. In certain embodiments, the computers 102 and/or servers 106 may connect to one or more internal or external direct-attached storage systems 110a (e.g., arrays of hard-disk drives, solid-state drives, tape drives, etc.). These computers 102, 106 and direct-attached storage systems 110a may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems, such as arrays 110b of hard-disk drives or solid-state drives, tape libraries 110c, individual hard-disk drives 110d or solid-state drives 110d, tape drives 110e, virtual tape systems, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC).

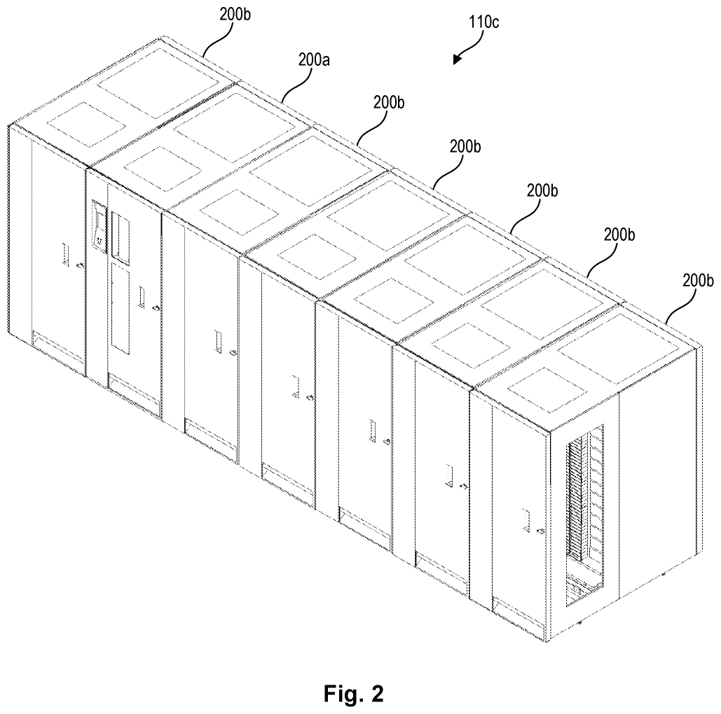

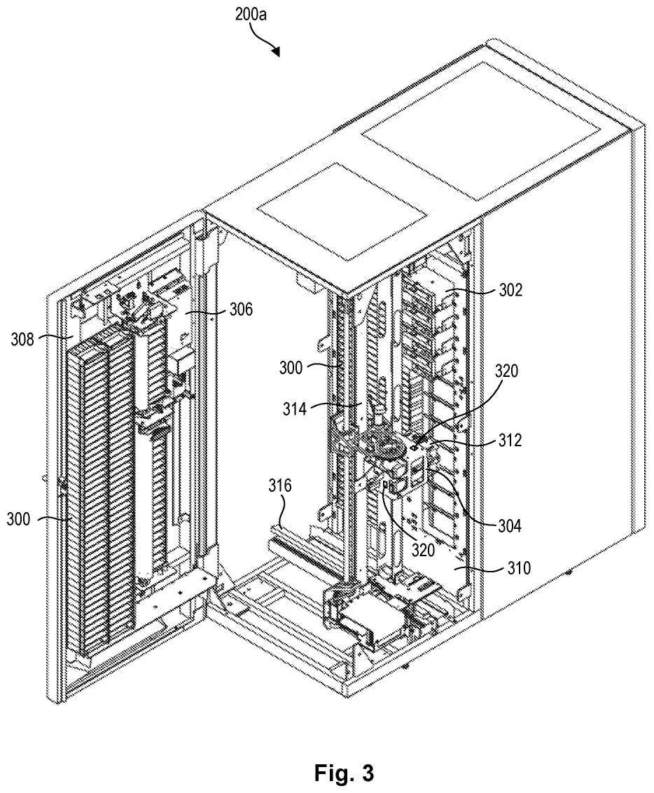

Referring to FIG. 2, one example of a tape library 110c for use in the network environment 100 of FIG. 1 is illustrated. The illustrated tape library 110c is a modular tape library 110c that comprises one or more frames 200. These frames 200 may contain tape drives and storage slots for storing tape cartridges. In certain embodiments, the tape library 110c includes a base frame 200a (as further illustrated in FIG. 3) to which optional expansion frames 200b may be added. This enables expansion of the tape library 110c as data storage needs grow. The expansion frames 200b may provide additional library components such as storage slots, drives, import/export stations, cartridge accessors, operator panels, or the like, to the tape library 110c. One non-limiting example of a tape library 110c having functionality similar to that illustrated in FIG. 1 is the IBM 3584 tape library. Nevertheless, the systems and methods disclosed herein are not limited to the illustrated tape library 110c, but may be applicable to other tape libraries 110c manufactured by IBM or other vendors.

Referring to FIG. 3, one embodiment of a tape library base frame 200a is illustrated. The base frame 200a itself may function as a single-frame tape library 110c. The base frame 200a may be adapted to access data on tape cartridges in response to commands from one or more external host systems 106. As shown, the base frame 200a includes storage slots 300 on a front wall 308 and rear wall 310 to store tape cartridges; one or more tape drives 302 to access data on the tape cartridges; and a cartridge accessor 304 to physically transport tape cartridges between the storage slots 300 and the tape drives 302. The base frame 200a may also optionally include an operator panel 306 or user interface to enable a user to interact with or service the tape library 110c. The base frame 200a may further include import and export stations to enable tape cartridges to be inserted or removed from the tape library 110c without disrupting operations.

To enable the movement of tape cartridges between the storage slots 300 and the tape drives 302, the cartridge accessor 304 may include a gripper and pivot assembly 312 that moves up and down on a cartridge accessor mast 314. Similarly, the cartridge accessor 304 may travel in left and right directions along a track 316. This dual movement enables the gripper and pivot assembly 312 to move in both X and Y directions. This X-Y movement allows the gripper and pivot assembly 312 to transport tape cartridges between the storage slots 300 and the tape drives 302. In certain embodiments, the gripper and pivot assembly 312 includes a reading device, such as a bar code scanner, to read identifying information on each tape cartridge.

As previously mentioned, one of the primary causes of downtime for tape libraries 110c is the need for physical intervention. Physical intervention may be required for problems such as stuck grippers 312, misaligned tape cartridges or other components, misplaced magazines or other components, or physical objects inside the tape library 110c. Such physical intervention is costly in terms of time and money because it typically requires on-site personnel. For example, it is impossible to remotely dial into a tape library 110c and discover that a screw was inadvertently left in a cell 200 during installation. Logs often do not indicate what caused a problem, but rather simply identify symptoms of a problem such as a gripper 312 experiencing unexpected hard stops. Furthermore, after a physical problem in a tape library 110c is fixed, robotic elements of the tape library 110c may need to recalibrate. This is often an extremely slow and inefficient process that may further extend an outage. For example, a full-size IBM TS3500 tape library 110c may take four hours to recalibrate.

In order to reduce downtime in data and IT centers, and enable remote diagnosis of problems in tape libraries 110c such as that illustrated in FIG. 3, one or more scanning devices 320 may be installed on robotics of the tape library 110c, such as on the cartridge accessor 304. These scanning devices 320 may gather location (i.e., position) and/or temperature data from components within the tape library 110c. In certain embodiments, multiple scanning devices 320 may be installed, such as on opposing sides of the cartridge accessor 304, to provide a 360 degree view and images of components within the tape library 110c. In certain embodiments, the scanning devices 320 are infrared (IR) scanning devices 320 that detect and identify infrared radiation emitted from components within the tape library 110c.

Because robotics associated with a cartridge accessor 304 enable the cartridge accessor 304 to move in left and right directions (X-motion) and up and down directions (Y-motion), the same robotics may move the scanning devices 320 relative to stationary components within the tape library 110c. This enables the scanning devices 320 to collect location and/or temperature data from components within the tape library 110c as they move relative to the components. In certain embodiments, the robotics may be programmed to move relative to the components in the tape library 110c in a designated pattern to gather location and/or temperature data associated with the components. In other embodiments, the scanning devices 320 may gather location and/or temperature data during normal and customary operation of the tape library robotics without requiring dedicated movements.

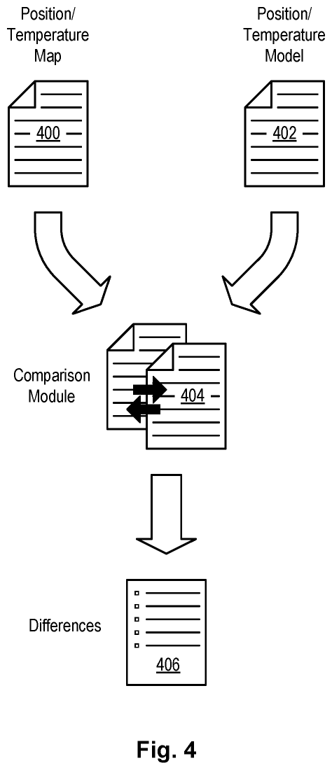

As shown in FIG. 4, location and/or temperature data may be used to create a position and/or temperature map 400 of components within the tape library 110c. This position and/or temperature map 400 may describe the position and/or temperature of components (e.g., tape drives, tape cartridges, cells, node cards, robotic elements, cables, fasteners such as screws, etc.) within the tape library 110c. The position and/or temperature map 400 may then be compared against a position and/or temperature model 402 that describes allowable positions and/or temperatures for components within the tape library 110c. In certain embodiments, the position and/or temperature model 402 is derived from engineering drawings or specifications that describe sizes, positions, calibrations, allowable operating temperatures, tolerances, or the like, for different components and areas within the tape library 110c.

In other embodiments, the position and/or temperature model 402 is derived from a previously known good configuration of the tape library 110c. For example, when a tape library 110c is initially set up and operating, internal components of the tape library 110c may be scanned to record their initial position, temperature, configuration, etc. This scanned information may be incorporated into a position and/or temperature model 402 and used as a reference point for future comparisons. As shown in FIG. 4, once the position and/or temperature map 400 and position and/or temperature model 402 are compared by a comparison module 404, a list of differences 406 may be generated. These differences may be provided to a user and may indicate problems or areas of concern within the tape library 110c. Because a scan of the tape library 110c may be initiated remotely without requiring on-site personnel, the functionality described above may reduce the need for physical intervention and provide increased ability to diagnose and address problems remotely.

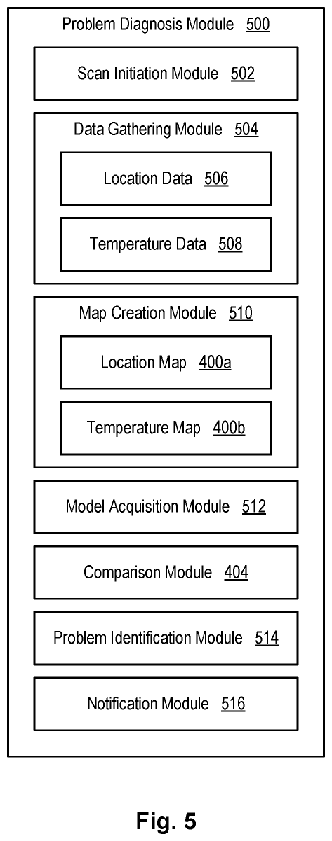

Referring to FIG. 5, in order to implement the functionality described above, a problem diagnosis module 500 may be provided. In certain embodiments, the problem diagnosis module 500 is executed on a computing system operably coupled to or in communication with the tape library 110c. The problem diagnosis module 500 may include various sub-modules to provide various features and functions. The problem diagnosis module 500 and sub-modules may be implemented in hardware, software, firmware, or combinations thereof. The problem diagnosis module 500 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules. As shown, the problem diagnosis module 500 includes one or more of a scan initiation module 502, data gathering module 504, map creation module 510, model acquisition module 512, comparison module 404, problem identification module 514, and notification module 516.

To initiated the processes described in FIG. 4, the scan initiation module 502 may initiate a scan of the tape library 110c. This scan initiation module 502 may be started by a user or automatically in response to an event such as a condition or error in the tape library 110c. As previously mentioned, tape library robotics may scan tape library components using different dedicated scanning patterns or during the course of normal tape library operations.

The data gathering module 504 may gather data from the scanning devices 320 as the scanning devices 320 move relative to the tape library components. This data may include location data 506 (the location data 506 collectively may be used to create images of components and features within the tape library 110c) and/or temperature data 508. The location data 506 may describe the physical positions of components within the tape library 110c, whereas the temperature data 508 may describe the temperature of various components or areas within the tape library 110c. Using data gathered by the data gathering module 504, the map creation module 510 may create maps of the internal components. These maps may include, for example, a location map 400a and a temperature map 400b.

The model acquisition module 512 may acquire position and/or temperature models 402 for the tape library 110c. As previously mentioned, these models 402 may be derived from engineering drawings/specifications, or from a previous scan of the tape library 110c. The comparison module 404 may then compare the position and/or temperature maps 400 to the position and/or temperature models 402 to find differences therebetween. Based on these differences, the problem identification module 514 may identify potential problems in the tape library 110c. These problems may include components that are out place, out of alignment, loose, worn down, outside of an allowable temperature range, not calibrated correctly, or the like. In certain embodiments, the location of problematic components may be recorded for later inspection. When differences or problems are detected, the notification module 516 may notify a user so that corrective actions may be taken. For example, the user may initiate service, replacement, or recalibration of components within the tape library 110c.

In certain cases, objects may appear in a map 400 that are not present or identifiable in a corresponding model 402. Systems and methods in accordance with the invention may, in certain embodiments, recognize such objects as being foreign. In such cases, external models may be imported or examined to identify the foreign object. For example, external models may be used to determine that a foreign object is a screwdriver or other tool inadvertently left in a tape library enclosure.

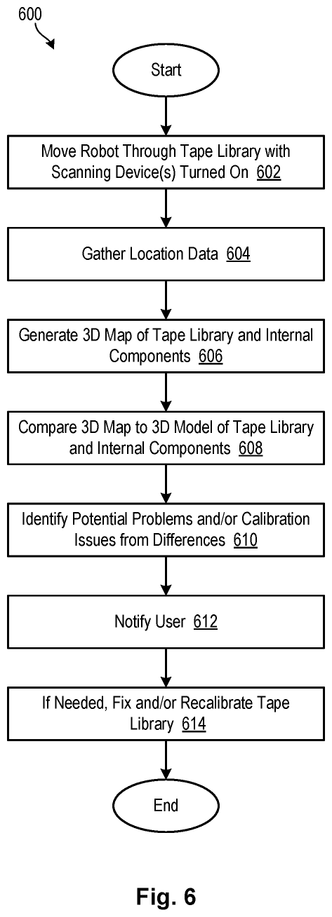

FIG. 6 shows one embodiment of a method 600 for diagnosing problems in a tape library 110c by acquiring and analyzing location data within the tape library 110c. Such a method 600 may, in certain embodiments, be executed by the problem diagnosis module 500 previously discussed. This method 600 is presented by way example and not limitation.

As shown, the method 600 initially moves 602 robotic elements such as a cartridge accessor 304 through a tape library 110c with the scanning devices 320 turned on. While these scanning devices 320 are moving through the tape library 110c, the method 600 gathers 604 location data for components therein. Using this location data, the method 600 generates 606 a three-dimensional (3D) map 400a of the tape library 110c and its internal components.

The method 600 then compares 608 the map 400a to a 3D model 402 of the tape library 110c and its internal components to determine differences. From these differences, the method 600 identifies 610 problems and/or calibration issues within the tape library 110c. The method further notifies 612 a user of these problems and/or calibration issues. Using this information, the user may fix 614 and/or recalibrate 614 components within the tape library 110c.

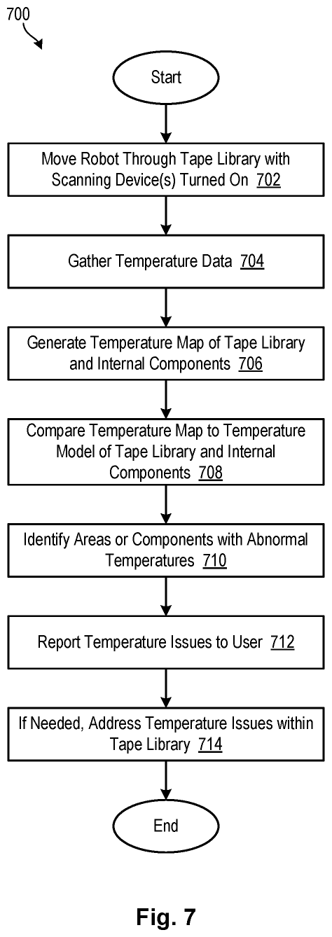

FIG. 7 shows one embodiment of a method 700 for diagnosing problems in a tape library 110c by acquiring and analyzing temperature data within the tape library 110c. Such a method 700 may, in certain embodiments, be executed by the problem diagnosis module 500 previously discussed. This method 700 is presented by way example and not limitation.

As shown, the method 700 initially moves 702 robotic elements such as a cartridge accessor 304 through a tape library 110c with the scanning devices 320 turned on. While these scanning devices 320 are moving through the tape library 110c, the method 700 gathers 704 temperature data for components within the tape library 110c. Using this temperature data, the method 700 generates 706 a temperature map 400b of components within the tape library 110c.

The method 700 then compares 708 the temperature map 400b to a temperature model 402 of the tape library 110c and its internal components. This may be performed to identify 710 components that have abnormal temperatures or fall outside allowable ranges. Such abnormal temperatures may be indicators of other problems within the tape library 110c. The method 700 then reports 712 the temperature issues to a user. Using this information, the user may address 714 the temperature issues such as by replacing components, recalibrating components, reducing the workload on certain components, reconfiguring certain components, or the like.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for diagnosing problems in tape libraries, the method comprising:
attaching, to a robot of a tape library, at least one scanning device to scan internal components of the tape library;
as the robot moves within the tape library, capturing, using the at least one scanning device, three-dimensional (3D) data describing physical locations of the internal components;
compiling the 3D data to generate a map of the internal components;
comparing the map to a 3D model of the tape library to identify differences between the map and the 3D model; and
identifying problems within the tape library from the differences.

2. The method of claim 1, wherein the at least one scanning device includes at least one infrared (IR) scanning device.

3. The method of claim 1, wherein the at least one scanning device gathers temperature data associated with the internal components.

4. The method of claim 3, further comprising comparing temperature data associated with the map to temperature data associated with the 3D model.

5. The method of claim 4, wherein identifying problems further comprises identifying differences between the temperature data associated with the map and the temperature data associated with the 3D model.

6. The method of claim 1, wherein the 3D model is derived from engineering drawings of the tape library and the internal components.

7. The method of claim 1, wherein the 3D model is derived from a previously generated map of the tape library and the internal components.

8. A computer program product for diagnosing problems in tape libraries, the computer program product comprising a computer-readable storage medium having computer-usable program code embodied therein, the computer-usable program code configured to perform the following when executed by at least one processor:
interface with at least one scanning device configured to scan internal components of a tape library, wherein the at least one scanning device is attached to a robot of the tape library;
as the robot moves within the tape library, capture, using the at least one scanning device, three-dimensional (3D) data describing physical locations of the internal components;
compile the 3D data to generate a map of the internal components; and
compare the map to a 3D model of the tape library to identify differences between the map and the 3D model.

9. The computer program product of claim 8, wherein the at least one scanning device includes at least one infrared (IR) scanning device.

10. The computer program product of claim 8, wherein the at least one scanning device gathers temperature data associated with the internal components.

11. The computer program product of claim 10, wherein the computer-usable program code is further configured to compare temperature data associated with the map to temperature data associated with the 3D model.

12. The computer program product of claim 8, wherein the computer-usable program code is further configured to identify problems within the tape library from the differences.

13. The computer program product of claim 8, wherein the 3D model is derived from engineering drawings of the tape library and the internal components.

14. The computer program product of claim 8, wherein the 3D model is derived from a previously generated map of the tape library and the internal components.

15. A system for diagnosing problems in tape libraries, the system comprising:
at least one processor;
at least one memory device operably coupled to the at least one processor and storing instructions for execution on the at least one processor, the instructions causing the at least one processor to:
interface with at least one scanning device configured to scan internal components of a tape library, wherein the at least one scanning device is attached to a robot of the tape library;
as the robot moves within the tape library, capture, using the at least one scanning device, three-dimensional (3D) data describing physical locations of the internal components;
compile the 3D data to generate a map of the internal components; and
compare the map to a 3D model of the tape library to identify differences between the map and the 3D model.

16. The system of claim 15, wherein the at least one scanning device includes at least one infrared (IR) scanning device.

17. The system of claim 15, wherein the at least one scanning device gathers temperature data associated with the internal components.

18. The system of claim 17, wherein the instructions further cause the at least one processor to compare temperature data associated with the map to temperature data associated with the 3D model.

19. The system of claim 15, wherein the 3D model is derived from engineering drawings of the tape library and the internal components.

20. The system of claim 15, wherein the 3D model is derived from a previously generated map of the tape library and the internal components.
